(19) United States
(12) Patent Application Publication
(10) Pub. No.: US 2022/0148017 A1
(43) Pub. Date: May 12, 2022

(54) PROCESSING APPARATUS, AND PROCESSING METHOD

(71) Applicant: NEC Corporation, Minato-ku, Tokyo (JP)

(72) Inventors: Soma SHIRAISHI, Tokyo (JP); Kota IWAMOTO, Tokyo (JP); Shinya YAMASAKI, Tokyo (JP)

(73) Assignee: NEC Corporation, Minato-ku, Tokyo (JP)

(21) Appl. No.: 17/432,552

(22) PCT Filed: Feb. 25, 2019
(86) PCT No.: PCT/JP2019/007019

§ 371 Date: Aug. 20, 2021

(51) Int. Cl. G06Q 30/02; G06V 20/64; G06V 20/70; G06V 10/42

(52) U.S. Cl. CPC G06Q 30/0201; G06Q 30/0202; G06V 10/42; G06V 20/70; G06V 20/64

(57) ABSTRACT

This invention provides a processing apparatus (10) including an image acquisition unit (11) that acquires an appearance image of each of a plurality of products, a sales-related information acquisition unit (12) that acquires sales-related information concerning the sales details of each of the plurality of products, a registration unit (13) that stores product identification information of each of the plurality of products, the sales-related information, and the appearance image in a storage unit (14) in association with each other, and an output unit (16) that arranges a plurality of appearance images associated with the identical product identification information in a predetermined order, based on the sales-related information, and outputs the plurality of arranged appearance images.

### TECHNICAL FIELD

The present invention relates to a processing apparatus, a processing method, and a program.

### BACKGROUND ART

Patent Document 1 discloses a product registration apparatus that allows a customer to effectively utilize image data acquired upon product recognition. The product registration apparatus includes a means for storing, for each of types of a plurality of products, a product image serving as a reference for the product, a means for determining a product to be sold, based on an image generated by capturing the product to be sold and the product image, and performing sales processing for the product to be sold, and a means for providing the image generated by capturing the product to be sold, as an image for storage intended for a customer who has purchased the product.

### RELATED DOCUMENT

### Patent Document

[Patent Document 1] Japanese Patent Application Publication No. 2016-115298

### DISCLOSURE OF THE INVENTION

### Technical Problem

Even identical products (products having the identical product identification information (a JAN code, and the like)) may not present completely the same appearance. Examples of such products include prepared food packed in see-through packaging. For such prepared food, even when a manual for arranging each object of the food is available, it is difficult to perfectly match orientation, an angle, and the like of the object with the manual. In addition, a state of arrangement of the object may nonuniformly vary upon transporting or displaying the products. Further, individual differences may even occur in a shape and a size of each of the object. Note that, a status as described above may occur in products other than such prepared food as well.

Such difference in appearance among identical products may influence sales performance, but no means for analyzing the influence has been available. Patent Document 1 does not describe the problem. The present invention aims to provide a technique for analyzing influence that difference in appearance among identical products exerts on sales performance thereof.

### Solution to Problem

According to the present invention, a processing apparatus including:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

an output means for arranging the plurality of appearance images associated with the identical product identification information in a predetermined order, based on the sales-related information, and outputting the plurality of arranged appearance images is provided.

According to the present invention, a processing apparatus including:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

a grouping means for grouping the plurality of appearance images associated with the identical product identification information, based on the sales-related information is provided.

According to the present invention, a processing method executed by a computer including:

an image acquisition step of acquiring an appearance image of each of a plurality of products;

a sales-related information acquisition step of acquiring sales-related information concerning a sales detail of each of the plurality of products;

a registration step of storing, in a storage means, product identification information of each of the plurality of products, the sales-related information, and the appearance image in association with one another; and

an output step of arranging the plurality of appearance images associated with the identical product identification information in a predetermined order, based on the sales-related information, and outputting the plurality of arranged appearance images is provided.

According to the present invention, a program for causing a computer to function as:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

an output means for arranging the plurality of appearance images associated with the identical product identification information in a predetermined order, based on the sales-related information, and outputting the plurality of arranged appearance images is provided.

According to the present invention, a processing method executed by a computer including:

an image acquisition step of acquiring an appearance image of each of a plurality of products;

a sales-related information acquisition step of acquiring sales-related information concerning a sales detail of each of the plurality of products;

a registration step of storing, in a storage means, product identification information of each of the plurality of products, the sales-related information, and the appearance image in association with one another; and

a grouping step of grouping the plurality of appearance images associated with the identical product identification information, based on the sales-related information is provided.

According to the present invention, a program for causing a computer to function as:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

a grouping means for grouping the plurality of appearance images associated with the identical product identification information, based on the sales-related information is provided.

### Advantageous Effects of Invention

The present invention implements a technique for analyzing influence that difference in appearance among identical products exerts on sales performance thereof.

### BRIEF DESCRIPTION OF THE DRAWINGS

The above and other objects, features, and advantages will be more apparent from the following description of preferred embodiments taken in conjunction with the following accompanying drawings.

FIG. 1 is a block diagram illustrating an exemplary hardware configuration of a processing apparatus according to this example embodiment.

FIG. 2 is an exemplary functional block diagram of a processing system according to this example embodiment.

FIG. 3 is another exemplary functional block diagram of the processing system according to this example embodiment.

FIG. 4 is an exemplary functional block diagram of the processing apparatus according to this example embodiment.

FIG. 5 is a table schematically illustrating exemplary information processed by the processing apparatus according to this example embodiment.

FIG. 6 is a diagram schematically illustrating exemplary information output by the processing apparatus according to this example embodiment.

FIG. 7 is a diagram schematically illustrating another exemplary information output by the processing apparatus according to this example embodiment.

FIG. 8 is a flowchart illustrating an exemplary sequence of processing by the processing apparatus according to this example embodiment.

FIG. 9 is a flowchart illustrating another exemplary sequence of the processing by the processing apparatus according to this example embodiment.

FIG. 10 is a flowchart illustrating still another exemplary sequence of the processing by the processing apparatus according to this example embodiment.

FIG. 11 is a flowchart illustrating still another exemplary sequence of the processing by the processing apparatus according to this example embodiment.

FIG. 12 is a diagram illustrating a placement example of a camera 30 according to this example embodiment.

FIG. 13 is a diagram illustrating another placement example of the camera 30 according to this example embodiment.

### DESCRIPTION OF EMBODIMENTS

### First Example Embodiment

An overview of a processing apparatus according to this example embodiment will be described first. The processing apparatus is used in marketing for a business owner who manages a store or a shop for retailing (for example, a convenience store, a supermarket, or a restaurant). The processing apparatus, for example, implements a system in cooperation with a POS terminal, a camera that captures the interior of the store, a store server, and the like. The processing apparatus acquires an appearance image representing the appearance of a product, that is, an appearance image of each of a plurality of products captured in accounting processing. The processing apparatus further acquires sales-related information concerning the sales details of each of the plurality of products. The sales-related information includes at least one of attribute information of a purchaser (for example, the age and the sex), attribute information of a store (for example, the address and neighboring facility information), attribute information of the sale date (for example, the day of the week, the weather, and the season), the time instant of sale, and the elapsed time from a reference timing (for example, the inspection timing or the delivery timing) to the sale timing. The processing apparatus stores product identification information, the sales-related information, and the appearance image in a storage means in association with each other.

The processing apparatus then performs at least one of “processing of arranging a plurality of appearance images associated with the identical product identification information in a predetermined order, based on the sales-related information, and outputting the plurality of appearance images,” and “processing of grouping a plurality of appearance images associated with the identical product identification information, based on the sales-related information.” With the plurality of appearance images having undergone either of these types of processing, the influence that the difference in appearance among identical products exert on their sales performance can be efficiently analyzed.

The configuration of the processing apparatus will be described in detail below. An exemplary hardware configuration of the processing apparatus will be set forth first. Each functional unit of the processing apparatus according to this example embodiment is implemented as any combination of hardware and software, mainly including a central processing unit (CPU) of any computer, a memory, a program loaded into the memory, a storage unit (capable of storing not only a program stored in advance at the stage of shipping the apparatus, but also a program downloaded from, for example, a storage medium such as a compact disc (CD) or a server on the Internet) such as a hard disk that stores the program, and an interface for network connection. It will be understood to those skilled in the art that various modifications can be made to the method for implementing these functional units, and the apparatus.

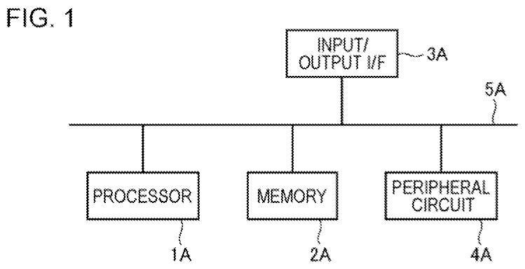

FIG. 1 is a block diagram illustrating the hardware configuration of the processing apparatus according to this example embodiment. The processing apparatus includes a processor 1A, a memory 2A, an input/output interface 3A, a peripheral circuit 4A, and a bus 5A, as illustrated in FIG. 1. The peripheral circuit 4A includes various modules. The processing apparatus may include no peripheral circuit 4A. Note that the processing apparatus may be formed by a plurality of apparatuses physically and/or logically separated from each other. In this case, each of the plurality of apparatuses can be equipped with the above-mentioned hardware configuration.

The bus 5A serves as a data transmission line for allowing the processor 1A, the memory 2A, the peripheral circuit 4A, and the input/output interface 3A to exchange data with each other. The processor 1A is implemented as an arithmetic processing apparatus such as a CPU or a graphics processing unit (GPU). The memory 2A is implemented as a memory such as a random access memory (RAM) or a read only memory (ROM). The input/output interface 3A includes, for example, an interface for acquiring information from an input apparatus, an external apparatus, an external server, an external sensor, a camera, and the like, and an interface for outputting information to an output apparatus, an external apparatus, an external server, and the like. Examples of the input apparatus include a keyboard, a mouse, a microphone, a physical button, and a touch panel. Examples of the output apparatus include a display, a loudspeaker, a printer, and a mailer. The processor 1A can issue commands to the respective modules and perform arithmetic operation based on the arithmetic results of these commands.

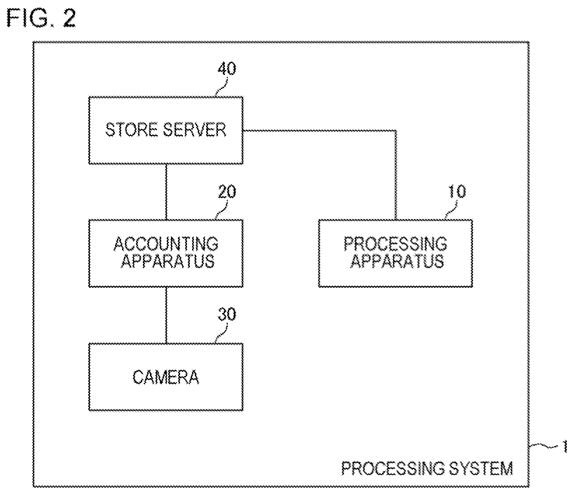

FIG. 2 illustrates an exemplary functional block diagram of a processing system 1 including a processing apparatus 10. The processing system 1 includes the processing apparatus 10, an accounting apparatus 20, a camera 30, and a store server 40, as illustrated in FIG. 2.

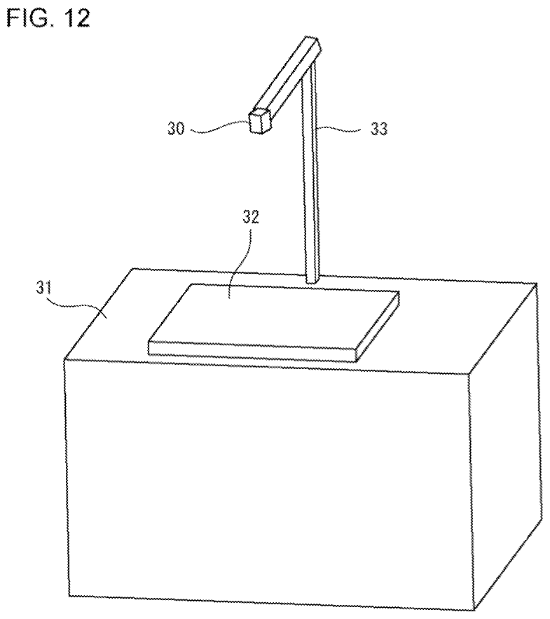

The camera 30 captures a product to be accounted for, in accounting processing. The camera 30 inputs a generated appearance image of the product to the accounting apparatus 20. The camera 30 may, for example, be placed in a position and orientation to capture a table to mount the product to be accounted for. The camera 30 may capture one product mounted on the table, or collectively capture a plurality of products mounted on it. FIG. 12 illustrates one example. In the example illustrated in FIG. 12, a mount area 32 to mount the product is formed on a table 31. The camera 30 is attached to a support column 33. The camera 30 is placed in a position and orientation to capture the mount area 32.

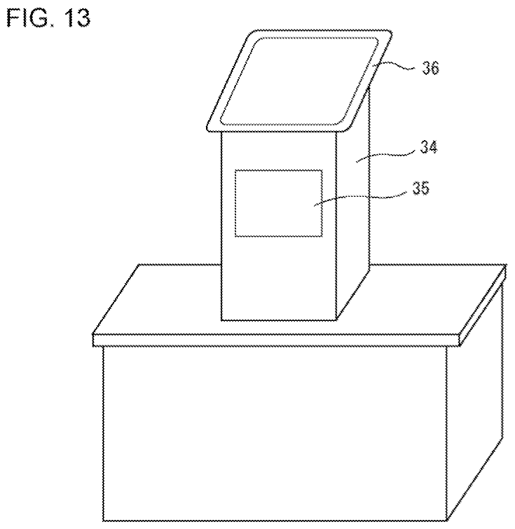

The camera 30 may also be placed in any position and orientation and capture one product held in front of the camera 30 by an operator. FIG. 13 illustrates one example. In the example illustrated in FIG. 13, the camera 30 (not illustrated) is placed in a housing 34. The camera 30 captures a product held in front of a window 35 that transmits light. A display 36 displays various types of information pertaining to accounting.

Note that the camera 30 may be physically separated from the accounting apparatus 20, or may be physically integrated with the accounting apparatus 20.

Referring back to FIG. 2, the accounting apparatus 20 performs accounting processing including registration processing and checkout processing. In the registration processing, the accounting apparatus 20 registers product information of a product to be accounted for. The accounting apparatus 20 may, for example, recognize a product, contained in the image generated by the camera 30 or an image obtained by editing or the like of the generated image, based on a feature of the appearance of the product. The accounting apparatus 20 may acquire product information (for example, the product name and the unit price) of the recognized product from a product master registered in the store server 40 in advance, and register it as product information of the product to be accounted for.

Note that the accounting apparatus 20 may transmit the image generated by the camera to the store server 40. The store server 40 may recognize a product, contained in the image generated by the camera 30 or an image obtained by editing or the like of the generated image, based on a feature of the appearance of the product, and transmit the recognition result to the accounting apparatus 20. The accounting apparatus 20 may acquire product information (for example, the product name and the unit price) of the recognized product from a product master registered in the store server 40 in advance, and register it as product information of the product to be accounted for.

Examples of the above-mentioned image having undergone editing or the like include a plurality of images generated by respectively cutting out a plurality of products contained in the image generated by the camera 30, but the present invention is not limited to these images. Such editing or the like may be performed either by the accounting apparatus 20 or by the store server 40.

The accounting apparatus 20 may even accept input of product identification information of a product to be accounted for, via an input apparatus such as a touch panel display, a physical button, a code reader, or a microphone. The accounting apparatus 20 may acquire, from a product master registered in the store server 40 in advance, product information of the product having the product identification information whose input has been accepted, and register it as product information of the product to be accounted for.

In the checkout processing, the accounting apparatus 20, for example, accepts input of cash as payment of a total amount of money computed based on the details registered in the registration processing, and outputs change, where necessary, and a receipt. The accounting apparatus 20 may also accept input of credit card information, communicate with a system in a credit card company, and perform settlement processing. The accounting apparatus 20 may even accept input of an amount of deposit deposited from a customer, compute an amount of change based on the input amount of deposit, display the amount of change on a display, and give back the computed change.

The above-mentioned techniques regarding the registration processing and the checkout processing are widely known, and a detailed description thereof will not be given herein.

The accounting apparatus 20 further acquires attribute information of a purchaser at any timing during execution of the registration processing and the checkout processing. An operator of the accounting apparatus 20 may, for example, input attribute information (for example, the age and the sex) of a purchaser to the accounting apparatus 20 via a physical button or a touch panel display. The accounting apparatus 20 may further acquire membership information of a customer by any means (for example, reading of card information, or near-field communication with a portable terminal or the like of the customer). The membership information may include attribute information (for example, the age and the sex) of a purchaser. Alternatively, the membership information may include member identification information, and need not always include attribute information (for example, the age and the sex) of a purchaser. In this case, any server stores attribute information (for example, the age and the sex) of a purchaser in association with the member identification information.

The accounting apparatus 20 transmits information processed in the registration processing and the checkout processing to the store server 40. The information transmitted to the store server 40 includes some or all of an appearance image, generated by the camera 30, of a product to be accounted for, product identification information of a product registered as a target to be accounted for (a product sold to a customer), attribute information of a purchaser, membership information of the purchaser, the sale date (the day on which accounting processing has taken place), and the time instant of sale (the time instant of any timing during the accounting processing). The accounting apparatus 20 transmits these pieces of information to the store server 40 in association with each other in every accounting processing.

The store server 40 transmits the above-mentioned pieces of information received from the accounting apparatus 20 to the processing apparatus 10. The store server 40 may further transmit attribute information (for example, the address) of a store to the processing apparatus 10. The store server 40 transmits these pieces of information to the processing apparatus 10 in association with each other in every accounting processing.

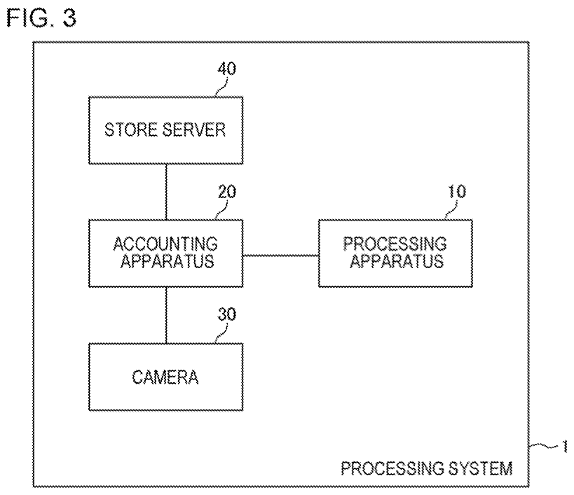

FIG. 3 illustrates another exemplary functional block diagram of the processing system 1. The accounting apparatus 20 may transmit various types of information to the processing apparatus 10 without the store server 40, as illustrated in FIG. 3. The accounting apparatus 20 may, for example, transmit, to the processing apparatus 10 without the store server 40, some or all of an appearance image of a product to be accounted for generated by the camera 30, product identification information of a product registered as a target to be accounted for (a product sold to a customer), attribute information of a purchaser, membership information of the purchaser, the sale date (the day on which accounting processing has taken place), and the time instant of sale (the time instant of any timing during the accounting processing). The accounting apparatus 20 may further transmit attribute information of a store (for example, the address) to the processing apparatus 10. The accounting apparatus 20 transmits these pieces of information to the processing apparatus 10 in association with each other in every accounting processing.

In this manner, in the processing system 1 according to this example embodiment, an appearance image of a product generated by capturing a product to be accounted for, and sales-related information concerning the sales details of the product are generated in every accounting processing, and these pieces of information are input to the processing apparatus 10 in association with each other in every accounting processing. The processing apparatus 10 performs processing for analyzing the influence that the difference in appearance among identical products exert on their sales performance, based on these pieces of information.

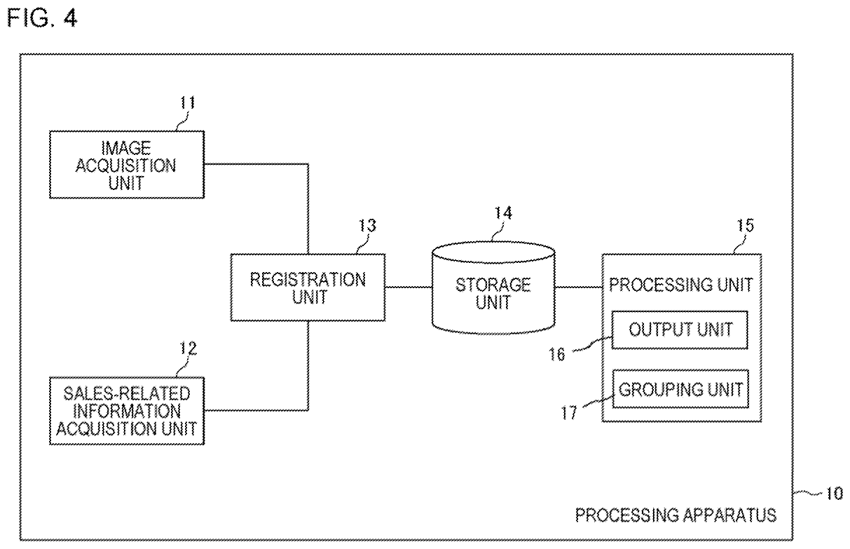

The functional configuration of the processing apparatus 10 will be described in detail below. As depicted in a functional block diagram of FIG. 4, the processing apparatus 10 includes an image acquisition unit 11, a sales-related information acquisition unit 12, a registration unit 13, a storage unit 14, and a processing unit 15. Note that the processing apparatus 10 may include no storage unit 14. In this case, an external apparatus designed to be communicable with the processing apparatus 10 includes the storage unit 14.

The image acquisition unit 11 acquires an appearance image representing the appearance of a product, that is, an appearance image of each of a plurality of products captured in accounting processing. The image acquisition unit 11 can acquire the appearance image from the store server 40 or the accounting apparatus 20.

The appearance image acquired by the image acquisition unit 11 may be implemented as the image itself generated by the camera 30, or as an image obtained by editing or the like of the image generated by the camera 30. Examples of the image having undergone editing or the like include a plurality of images generated by respectively cutting out a plurality of products contained in the image generated by the camera 30, but the present invention is not limited to these images. Such editing or the like may be performed either by the accounting apparatus 20 or by the store server 40. The image acquisition unit 11 may even acquire the image generated by the camera 30 from the store server 40 or the accounting apparatus 20, and then perform the above-mentioned editing or the like on this image.

Note that in this specification, “acquisition” includes at least one of “retrieving, by the apparatus involved, data stored in other apparatuses or a storage medium (active acquisition),” based on user input or based on a program instruction, such as receiving data by requesting or inquiring them of other apparatuses, or accessing other apparatuses or a storage medium and reading data, and “inputting, to the apparatus involved, data output from other apparatuses (passive acquisition),” based on user input or based on a program instruction, such as receiving data delivered (or, for example, transmitted or sent by push notification), or acquiring data by selecting them from received data or information; and “acquiring new data by generating the new data by, for example, editing data (for example, conversion into text format, data sorting, extraction of partial data, and a change in file format).”

The sales-related information acquisition unit 12 acquires sales-related information concerning the sales details of each of a plurality of products.

The sales-related information acquisition unit 12 can acquire sales-related information from the store server 40 or the accounting apparatus 20. The sales-related information acquisition unit 12 can, for example, acquire, from the store server 40 or the accounting apparatus 20, some or all of product identification information of a product registered as a target to be accounted for (a product sold to a customer), attribute information of a purchaser (for example, the age and the sex), membership information of the purchaser, the sale date (the day on which accounting processing has taken place), and the time instant of sale (the time instant of any timing during the accounting processing). The sales-related information acquisition unit 12 can further acquire attribute information of a store (for example, the address) from the store server 40 or the accounting apparatus 20.

The sales-related information acquisition unit 12 can also acquire sales-related information from other servers. The sales-related information acquisition unit 12 may, for example, acquire attribute information associated with member identification information of a purchaser from a server that stores member identification information and attribute information of a member (for example, the age and the sex) in association with each other. The sales-related information acquisition unit 12 may further acquire the day of the week (attribute information) and the season of the sale date from a server that stores calendar information. The sales-related information acquisition unit 12 may further acquire weather information of the sale date from a server that stores weather information (for example, the weather condition, the maximum temperature, the minimum temperature, and the humidity of each day). The sales-related information acquisition unit 12 may further acquire information representing a facility located in the neighborhood of each store (for example, within a predetermined distance from) from a server that stores map information.

The sales-related information acquisition unit 12 may even generate sales-related information, based on acquired information. The sales-related information acquisition unit 12 may, for example, compute, for each product, an elapsed time from a reference timing to the sale timing (time instant of sale), based on the time instant of sale (the time instant of any timing during the accounting processing) of each product registered as a target to be accounted for. Based on the elapsed time, the times respectively taken for a plurality of products to be sold are compared with each other. The reference timing need only be set to a timing that allows such a comparison. The timing of inspection conducted for a product delivered to a store, or the date and time of manufacture of each product, for example, can be set as the reference timing, but the present invention is not limited to these timings.

A reference timing for each product may be registered in the store server 40 or other servers, for each lot (for example, each production lot). The sales-related information acquisition unit 12 may acquire a reference timing associated with lot identification information of each product from any of these servers, and use it for the above-mentioned computation. The sales-related information acquisition unit 12 can acquire the lot identification information of each product from the store server 40 or the accounting apparatus 20. A code assigned to each product, for example, may indicate the lot identification information. The accounting apparatus may acquire the lot identification information of each product by reading the code or analyzing an image containing the code.

The sales-related information acquisition unit 12 may acquire information input by an operator, instead of or in addition to processing of acquiring information from other apparatuses or servers, or generating information by the own apparatus.

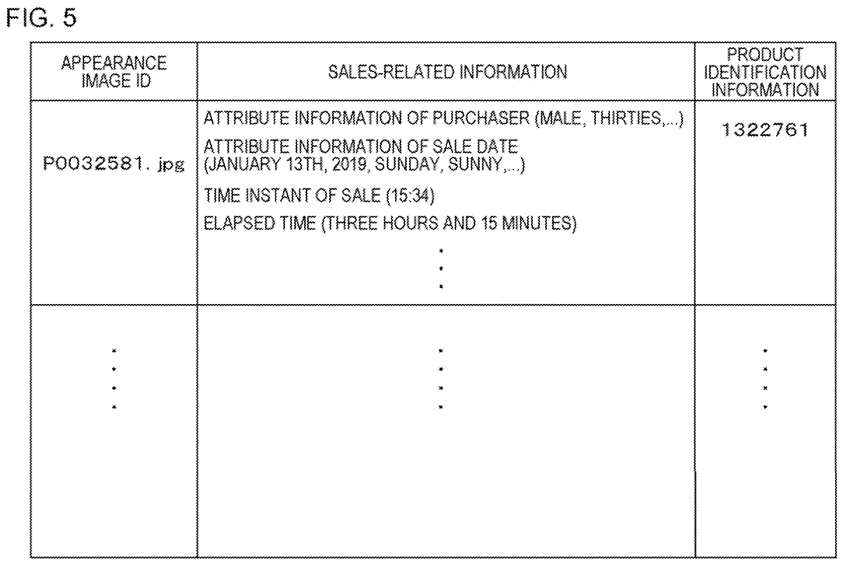

The registration unit 13 stores product identification information of each of a plurality of products, sales-related information acquired by the sales-related information acquisition unit 12, and an appearance image of each product acquired by the image acquisition unit 11, in the storage unit 14 in association with each other. FIG. 5 schematically illustrates exemplary information stored in the storage unit 14. In the example illustrated in FIG. 5, an appearance image identifier (ID), sales-related information, and product identification information are stored in association with each other.

As described above, the store server 40 or the accounting apparatus 20 transmits an appearance image and sales-related information of a product to the processing apparatus 10 in association with each other in every accounting processing. The registration unit 13 stores the appearance image and the sales-related information associated with each other, in the storage unit 14 in association with each other.

A means for associating an appearance image and product identification information with each other by the registration unit 13 will be described hereinafter. For example, in accounting processing, when a product contained in an appearance image generated by the camera 30 is recognized by analyzing the appearance image, and the recognized product is registered as a target to be accounted for, the store server 40 or the accounting apparatus 20 may transmit the appearance image and product identification information of the recognized product to the processing apparatus 10 in association with each other. In this example, the registration unit 13 stores the appearance image and the product identification information associated with each other, in the storage unit 14 in association with each other.

An operator of the processing apparatus 10 may even recognize a product contained in each appearance image by browsing the appearance images, and perform input for associating product identification information of the recognized product with each appearance image. In this example, the registration unit 13 stores the appearance image and the product identification information associated with each other by the input of the operator, in the storage unit 14 in association with each other.

The registration unit 13 may even recognize a product contained in the appearance image acquired by the image acquisition unit 11, based on a feature of the appearance of the product. In this example, the registration unit 13 stores the appearance image and product identification information of the product recognized to be contained in each appearance image, in the storage unit 14 in association with each other.

Referring back to FIG. 4, the processing unit 15 includes at least one of an output unit 16 and a grouping unit 17. The output unit 16 arranges a plurality of appearance images associated with the same product identification information in a predetermined order, based on the sales-related information, and outputs the plurality of appearance images. The grouping unit 17 groups a plurality of appearance images associated with the same product identification information, based on the sales-related information.

The output unit 16 may, for example, arrange the plurality of appearance images in descending order or ascending order of the above-mentioned elapsed time, and output them. The output by the output unit 16 is implemented via any output apparatus such as a display, a printer, or a mailer (the same or similar description applies hereinafter).

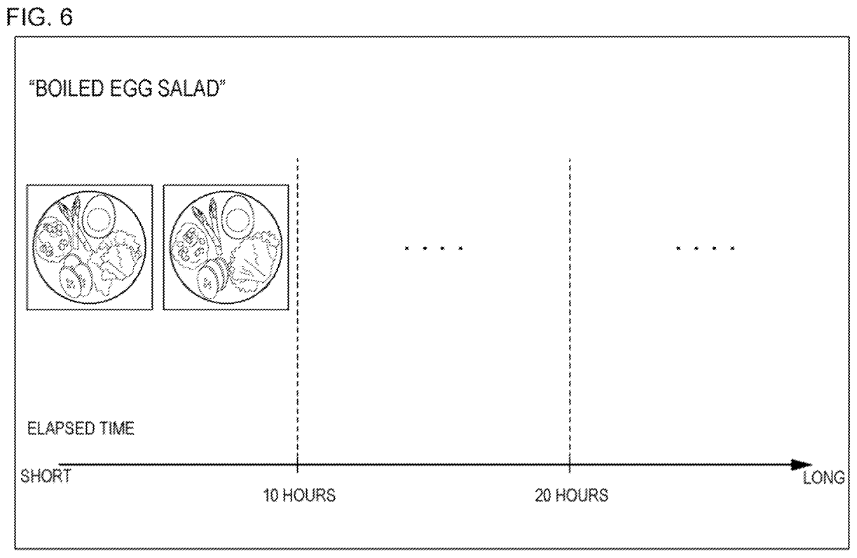

FIG. 6 illustrates exemplary information output from the output unit 16. In the example illustrated in FIG. 6, appearance images of “boiled egg salads” are arranged in ascending order of elapsed time (that is, in the order of sales having been made earlier). An operator can analyze, for example, a feature of the appearance of a product that sells relatively quickly, and a feature of the appearance of a product that sells relatively slowly, by browsing this information.

The grouping unit 17 groups the plurality of appearance images, based on the sales-related information, and collectively outputs the appearance images for each group. The output by the grouping unit 17 is implemented via any output apparatus such as a display, a printer, or a mailer (the same or similar description applies hereinafter).

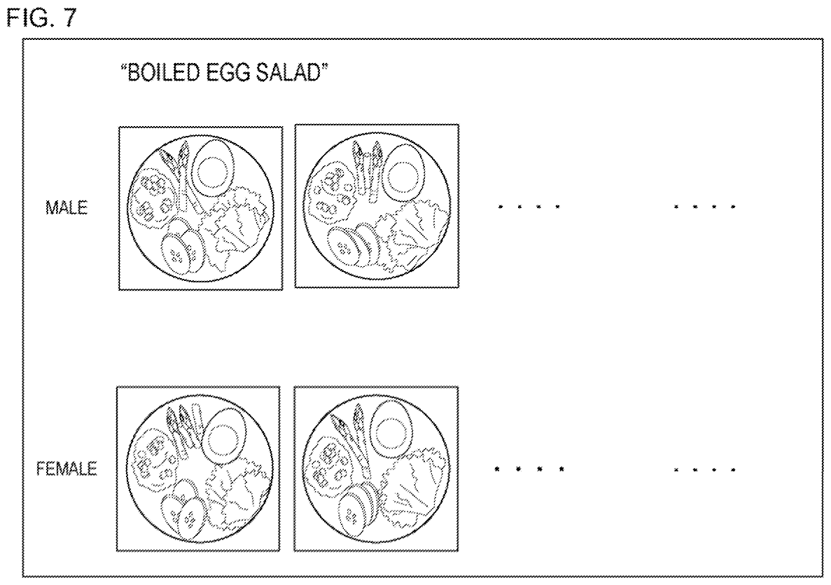

FIG. 7 illustrates exemplary information output from the grouping unit 17. In the example illustrated in FIG. 7, appearance images of “boiled egg salads” are grouped based on attribute information of purchasers (sexes), and collectively output for each group. An operator can analyze, for example, a feature of the appearance of a product that sells well to men, and a feature of the appearance of a product that sells well to women, by browsing this information.

Note that the method for grouping based on the sales-related information is not limited to this example. This method may be implemented as, for example, grouping based on the age of a purchaser, grouping for each store, grouping for each area of a store, grouping for each store having the same facility in its neighborhood, grouping for each day of the week, grouping for each season, grouping for each weather condition, grouping based on the maximum temperature, grouping based on the minimum temperature, grouping based on the humidity, grouping based on the above-mentioned elapsed time, or grouping based on a plurality of types of sales-related information.

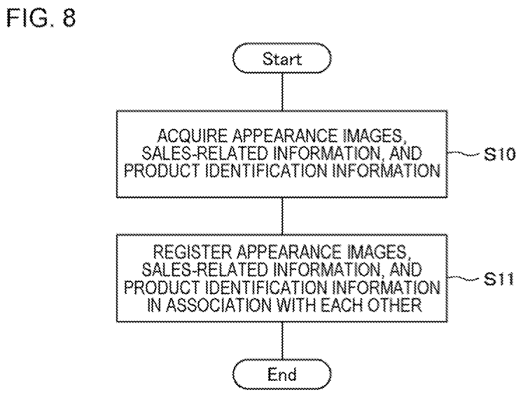

An exemplary sequence of processing by the processing apparatus 10 according to this example embodiment will be described below with reference to a flowchart of FIG. 8.

When the processing apparatus 10 acquires an appearance image of each of a plurality of products captured in accounting processing, and sales-related information concerning the sales details of each of the plurality of products from the store server 40 or the accounting apparatus (S10), it stores product identification information of each of the plurality of products, the sales-related information, and the appearance image in the storage unit 14 in association with each other (S11).

The processing apparatus 10 may acquire an appearance image generated upon accounting processing in one store and sales-related information from the store server 40 or the accounting apparatus 20 of this store, and store them in the storage unit 14, or may acquire appearance images generated upon accounting processing in a plurality of stores and sales-related information from the store servers 40 or the accounting apparatuses 20 of these stores, and store them in the storage unit 14.

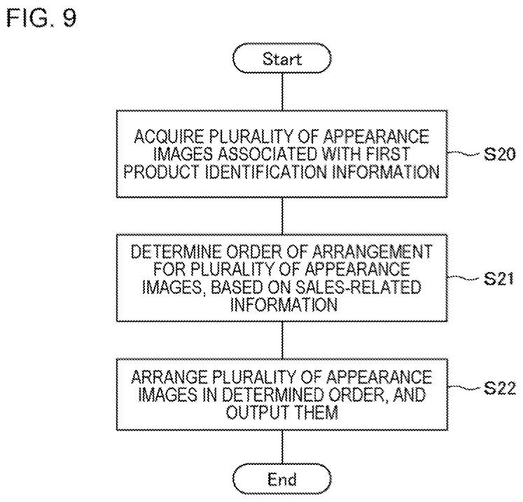

Another exemplary sequence of the processing by the processing apparatus 10 according to this example embodiment will be described below with reference to a flowchart of FIG. 9. The processing illustrated in the flowchart of FIG. 9 is performed at any timing after various types of information is accumulated in the storage unit 14 by the processing illustrated in the flowchart of FIG. 8.

The processing apparatus 10 first acquires appearance images stored in the storage unit 14 in association with any first product identification information (S20). The first product identification information may be implemented as product identification information specified by an operator, or as other types of information.

The processing apparatus 10 then determines an order of arrangement for a plurality of appearance images, based on the sales-related information stored in the storage unit 14 in association with each appearance image acquired in step S20 (S21). The processing apparatus 10, for example, determines an order of arrangement for a plurality of appearance images in descending order or ascending order of elapsed time from a reference timing to the sale timing.

The processing apparatus 10 arranges the appearance images acquired in step S20 in the order of arrangement determined in step S21, and outputs these appearance images (S22). The processing apparatus 10, for example, outputs information as depicted in FIG. 6. In the example illustrated in FIG. 6, appearance images of “boiled egg salads” are arranged in ascending order of elapsed time.

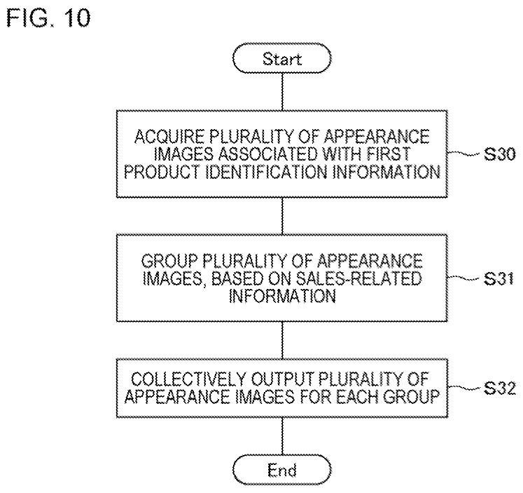

Still another exemplary sequence of the processing by the processing apparatus 10 according to this example embodiment will be described below with reference to a flowchart of FIG. 10. The processing illustrated in the flowchart of FIG. 10 is performed at any timing after various types of information is accumulated in the storage unit 14 by the processing illustrated in the flowchart of FIG. 8.

The processing apparatus 10 first acquires appearance images stored in the storage unit 14 in association with any first product identification information (S30). The first product identification information may be implemented as product identification information specified by an operator, or as other types of information.

The processing apparatus 10 then groups a plurality of appearance images, based on the sales-related information stored in the storage unit 14 in association with each appearance image acquired in step S30 (S31). The processing apparatus 10 may, for example, perform grouping for each sex of a purchaser, grouping based on the age of the purchaser, grouping for each store, grouping for each area of a store, grouping for each store having the same facility in its neighborhood, grouping for each day of the week, grouping for each season, grouping for each weather condition, grouping based on the maximum temperature, grouping based on the minimum temperature, grouping based on the humidity, grouping based on the above-mentioned elapsed time, or grouping based on a plurality of types of sales-related information.

The processing apparatus 10 collectively outputs the appearance images acquired in step S30, for each group determined in step S31 (S32). The processing apparatus 10, for example, outputs information as depicted in FIG. 7. In the example illustrated in FIG. 7, appearance images of “boiled egg salads” are grouped based on attribute information (sexes) of purchasers and collectively output for each group.

With the processing system 1 according to this example embodiment as described above, a captured image of a product to be accounted for, and sales-related information concerning the sales details of the product can be generated and input to the processing apparatus 10, in every accounting processing. The processing apparatus 10 can perform processing for analyzing the influence that the difference in appearance among identical products exert on their sales performance, based on these pieces of information.

The processing apparatus 10 can, for example, arrange a plurality of appearance images associated with the identical product identification information in a predetermined order (ascending order or descending order of elapsed time from a reference timing to the sale timing), and output the plurality of appearance images. An operator can analyze, for example, a feature of the appearance of a product that sells relatively quickly, and a feature of the appearance of a product that sells relatively slowly, by browsing this information.

The processing apparatus 10 can also group a plurality of appearance images associated with the identical product identification information, based on predetermined sales-related information, and collectively output the plurality of appearance images for each group. The processing apparatus 10 may, for example, perform grouping based on the sex or the age of a purchaser, grouping for each store, grouping for each area of a store, grouping for each store having the same facility in its neighborhood, grouping for each day of the week, grouping for each season, grouping for each weather condition, grouping based on the maximum temperature, the minimum temperature, the humidity, or the like, grouping based on the elapsed time from a reference timing to the sale timing, or grouping based on a plurality of types of sales-related information. An operator can analyze, for example, a feature of the appearance of a product that sells well in each case, and a feature of the appearance of a product that sells poorly in each case, by browsing this information.

In this manner, the processing system 1 and the processing apparatus 10 according to this example embodiment implement a technique for analyzing the influence that the difference in appearance among identical products exert on their sales performance.

### Second Example Embodiment

This example embodiment is different from the first example embodiment in terms of the configuration of a grouping unit 17 of a processing apparatus 10. Other configurations of the processing apparatus 10 and a processing system 1 are similar to those in the first example embodiment.

The grouping unit 17 groups a plurality of appearance images, based on the sales-related information, and extracts and outputs a feature common to the appearance images for each group. The processing of grouping the appearance images is similar to that described in the first example embodiment.

A variety of means are available for extracting a feature common to a plurality of appearance images belonging to each group. In the case of, for example, boiled egg salads as depicted in FIG. 7, a boiled egg may be detected based on a feature of its appearance from each appearance image, and the orientation, the angle, the size, the shape, and the like of each detected boiled egg may be extracted.

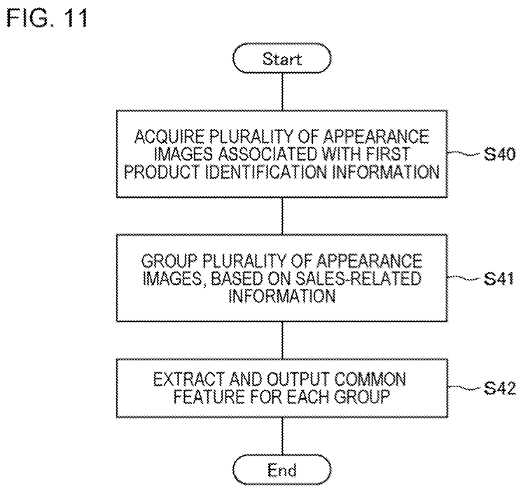

An exemplary sequence of processing by the processing apparatus 10 according to this example embodiment will be described below with reference to a flowchart of FIG. 11. The processing illustrated in the flowchart of FIG. 11 is performed at any timing after various types of information is accumulated in the storage unit 14 by the processing illustrated in the flowchart of FIG. 8.

The processing apparatus 10 first acquires appearance images stored in the storage unit 14 in association with any first product identification information (S40). The first product identification information may be implemented as product identification information specified by an operator, or as other types of information.

The processing apparatus 10 then groups a plurality of appearance images, based on the sales-related information stored in the storage unit 14 in association with each appearance image acquired in step S40 (S41). The processing apparatus 10 may, for example, perform grouping for each sex of a purchaser, grouping based on the age of the purchaser, grouping for each store, grouping for each area of a store, grouping for each store having the same facility in its neighborhood, grouping for each day of the week, grouping for each season, grouping for each weather condition, grouping based on the maximum temperature, grouping based on the minimum temperature, grouping based on the humidity, grouping based on the above-mentioned elapsed time, or grouping based on a plurality of types of sales-related information.

The processing apparatus 10 extracts and outputs a feature common to the appearance images included in each group, for each group determined in step S41 (S42).

The processing system 1 and the processing apparatus 10 according to this example embodiment as described above achieve advantageous effects similar to those of the processing system 1 and the processing apparatus 10 according to the first example embodiment. The processing system 1 and the processing apparatus 10 according to this example embodiment can even cause a computer to analyze and output the influence that the difference in appearance among identical products exert on their sales performance. Therefore, a difference in appearance among identical products that is less noticeable to an operator, for example, can even be detected.

### Third Example Embodiment

This example embodiment is different from the first and second example embodiments in that in the former, a processing apparatus 10 further acquires an appearance image of each product remaining unsold, and sales-related information indicating that this product remains unsold, and stores them in a storage unit 14. Other configurations in this example embodiment are similar to those in the first or second example embodiment.

An operator, for example, takes an unsold product out of a product display shelf, and then uses the camera 30 to capture the product. The operator registers an appearance image of the unsold product generated by the camera 30, in the store server 40 in association with information indicating that this product remains unsold. The store server 40 transmits, to the processing apparatus 10, the appearance image of the unsold product, and the sales-related information indicating that this product remains unsold, and associated with this appearance image. The store server 40 may further transmit attribute information (for example, the address and neighboring facility information) of a store to the processing apparatus 10.

The grouping unit 17 can further use the sales-related information to group a plurality of appearance images, and perform the processing described in the first or second example embodiment.

The processing system 1 and the processing apparatus 10 according to this example embodiment as described above achieve advantageous effects similar to those of the processing system 1 and the processing apparatus 10 according to each of the first and second example embodiments. The processing system 1 and the processing apparatus 10 according to this example embodiment can even analyze a feature of an unsold product as well.

### <Modifications>

A Modification applicable to all the example embodiments will be described hereinafter. In each of the above-described example embodiments, the output unit 16 and the grouping unit 17 output various types of information via any output apparatus such as a display, a printer, or a mailer, but in the Modification, the output unit 16 and the grouping unit 17 may notify a notification partner registered in advance of various types of information. Examples of communication means include e-mail and push notification by an application, but the present invention is not limited to these examples. Using this function, a product development branch of a head office or a product manufacturing plant, for example, can be notified of various types of information as described above. The notification partner can perform, for example, product layout management, based on the notification details.

Another Modification applicable to all the example embodiments will be described below. In each of the above-described example embodiments, an example in which a product is captured near the accounting apparatus 20 has been given, but the product may be captured at other positions. For example, the camera 30 may be placed in a position and orientation to capture a product displayed on a product shelf. In this example, the image acquisition unit 11 of the processing apparatus 10 acquires, from images generated by the camera 30, an appearance image of each product at the timing at which a customer picks up this product. The sales-related information acquisition unit 12 can acquire, as information concerning a purchaser, for example, membership information of the purchaser input at a gate upon his or her entrance to a store, and attribute information (for example, the age and the sex) of the purchaser registered in association with the membership information in advance. The sales-related information acquisition unit 12 may even determine the purchaser by face recognition processing based on the image generated by the camera 30.

Although the present invention has been described above with reference to the example embodiments (and examples), the present invention is not limited to the above-described example embodiments (and examples). Various changes that can be understood by those skilled in the art can be made to the configurations and details of the present invention within the scope of the present invention.

Part or all of the above-described example embodiments may be described as in the following supplementary notes, but they are not limited thereto.

1. A processing apparatus including:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

an output means for arranging the plurality of appearance images associated with the identical product identification information in a predetermined order, based on the sales-related information, and outputting the plurality of arranged appearance images.

2. The processing apparatus according to supplementary note 1, wherein

the output means arranges the plurality of appearance images in descending order or ascending order of elapsed time from a reference timing to a sale timing, and outputs the plurality of arranged appearance images.

3. A processing apparatus including:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

a grouping means for grouping the plurality of appearance images associated with the identical product identification information, based on the sales-related information.

4. The processing apparatus according to supplementary note 3, wherein

the grouping means groups the plurality of appearance images, based on the sales-related information, and collectively outputs the appearance images for each group.

5. The processing apparatus according to supplementary note 3 or 4, wherein

the grouping means groups the plurality of appearance images, based on the sales-related information, and extracts a feature common to the appearance images for each group.

6. The processing apparatus according to any one of supplementary notes 1 to 5, wherein

the sales-related information acquisition means acquires, as the sales-related information, at least one of attribute information of a purchaser, attribute information of a store, attribute information of a sale date, a time instant of sale, and an elapsed time from a reference timing to a sale timing.

7. The processing apparatus according to supplementary note 6, wherein

the reference timing is a timing of inspection conducted for a product delivered to a store.

8. The processing apparatus according to any one of supplementary notes 1 to 7, wherein

the image acquisition means further acquires the appearance image of each product remaining unsold, and

the sales-related information acquisition means further acquires, as the sales-related information, information indicating that the each product remains unsold.

9. A processing method executed by a computer including:

an image acquisition step of acquiring an appearance image of each of a plurality of products;

a sales-related information acquisition step of acquiring sales-related information concerning a sales detail of each of the plurality of products;

a registration step of storing, in a storage means, product identification information of each of the plurality of products, the sales-related information, and the appearance image in association with one another; and

an output step of arranging the plurality of appearance images associated with the identical product identification information in a predetermined order, based on the sales-related information, and outputting the plurality of arranged appearance images.

10. A program for causing a computer to function as:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

an output means for arranging the plurality of appearance images associated with the identical product identification information in a predetermined order, based on the sales-related information, and outputting the plurality of arranged appearance images.

11. A processing method executed by a computer including:

an image acquisition step of acquiring an appearance image of each of a plurality of products;

a sales-related information acquisition step of acquiring sales-related information concerning a sales detail of each of the plurality of products;

a registration step of storing, in a storage means, product identification information of each of the plurality of products, the sales-related information, and the appearance image in association with one another; and

a grouping step of grouping the plurality of appearance images associated with the identical product identification information, based on the sales-related information.

12. A program for causing a computer to function as:

an image acquisition means for acquiring an appearance image of each of a plurality of products;

a sales-related information acquisition means for acquiring sales-related information concerning a sales detail of each of the plurality of products;

a registration means for storing, in a storage means, product identification information of each of the plurality of products, the sales-related information, and the appearance image in association with one another; and

a grouping means for grouping the plurality of appearance images associated with the identical product identification information, based on the sales-related information.

What is claimed is:

1. A processing apparatus comprising:
at least one memory configured to store one or more instructions; and
at least one processor configured to execute the one or more instructions to:
acquire an appearance image of each of a plurality of products;
acquire sales-related information concerning a sales detail of each of the plurality of products;
store product identification information of each of the plurality of products, the sales-related information, and the appearance image in association with one another; and
arrange the plurality of appearance images associated with the identical product identification information in a predetermined order, based on the sales-related information, and output the plurality of arranged appearance images.

2. The processing apparatus according to claim 1, wherein
the processor is further configured to execute the one or more instructions to arrange the plurality of appearance images in descending order or ascending order of elapsed time from a reference timing to a sale timing, and output the plurality of arranged appearance images.

3. A processing apparatus comprising:
at least one memory configured to store one or more instructions; and
at least one processor configured to execute the one or more instructions to:
acquire an appearance image of each of a plurality of products;
acquire sales-related information concerning a sales detail of each of the plurality of products;
store product identification information of each of the plurality of products, the sales-related information, and the appearance image in association with one another; and
group the plurality of appearance images associated with the identical product identification information, based on the sales-related information.

4. The processing apparatus according to claim 3, wherein
the processor is further configured to execute the one or more instructions to group the plurality of appearance images, based on the sales-related information, and collectively output the appearance images for each group.

5. The processing apparatus according to claim 3, wherein
the processor is further configured to execute the one or more instructions to group the plurality of appearance images, based on the sales-related information, and extract a feature common to the appearance images for each group.

6. The processing apparatus according to claim 1, wherein
the processor is further configured to execute the one or more instructions to acquire, as the sales-related information, at least one of attribute information of a purchaser, attribute information of a store, attribute information of a sale date, a time instant of sale, and an elapsed time from a reference timing to a sale timing.

7. The processing apparatus according to claim 6, wherein
the reference timing is a timing of inspection conducted for a product delivered to a store.

8. The processing apparatus according to claim 1, wherein the processor is further configured to execute the one or more instructions to:
acquire the appearance image of each product remaining unsold, and
acquire, as the sales-related information, information indicating that the each product remains unsold.

9. A processing method executed by a computer comprising:
acquiring an appearance image of each of a plurality of products;
acquiring sales-related information concerning a sales detail of each of the plurality of products;
storing product identification information of each of the plurality of products, the sales-related information, and the appearance image in association with one another; and
arranging the plurality of appearance images associated with the identical product identification information in a predetermined order, based on the sales-related information, and outputting the plurality of arranged appearance images.

10.-12. (canceled)
